(19) United States
(12) Patent Application Publication
(10) Pub. No.: US 2015/0286270 A1
(43) Pub. Date: Oct. 8, 2015

(54) METHOD AND SYSTEM FOR REDUCING POWER CONSUMPTION WHILE IMPROVING EFFICIENCY FOR A MEMORY MANAGEMENT UNIT OF A PORTABLE COMPUTING DEVICE

(71) Applicant: QUALCOMM INCORPORATED, SAN DIEGO, CA (US)

(72) Inventors: Sreekumar Padmanabhan, Bangalore (IN); Satyaki Mukherjee, Bangalore (IN)

(73) Assignee: QUALCOMM INCORPORATED, SAN DIEGO, CA (US)

(21) Appl. No.: 14/291,100

(22) Filed: May 30, 2014

Related U.S. Application Data
(63) Continuation-in-part of application No. 14/243,706, filed on Apr. 2, 2014.

(51) Int. Cl. G06F 1/32; G06F 12/08; G06F 12/10

(52) U.S. Cl. CPC G06F 1/3275; G06F 12/1009; G06F 12/0862; G06F 2212/654

(57) ABSTRACT

A method and system for reducing power consumption while improving efficiency of a memory management unit of a portable computing device include determining if data of a memory request exists within a first memory element external to the memory management unit. The first memory element may include a cache. If the data of the memory request does not exist within the first memory element, then a magnitude of a burst length value of the memory request may be determined. Subsequently, a page table walk may be conducted with a second memory element, such as DDR (double-data rate) memory, that corresponds with the magnitude of the burst length value of second memory element (DDR). Each memory request may include a descriptor. The descriptor may have a reserved field region that includes a pre-fetch hint which indicates whether next descriptors in the second memory element are valid or not.

### STATEMENT REGARDING RELATED APPLICATIONS

This application claims priority under 35 U.S.C. §120 to and is a continuation-in-part of U.S. Non-Provisional patent application Ser. No. 14/243,706, filed on Apr. 2, 2014, entitled, “METHOD AND SYSTEM FOR REDUCING POWER CONSUMPTION WHILE IMPROVING EFFICIENCY FOR A MEMORY MANAGEMENT UNIT OF A PORTABLE COMPUTING DEVICE DESCRIPTION OF THE RELATED ART,” the entire contents of which are hereby incorporated by reference.

### BACKGROUND

Portable computing devices (“PCDs”) are becoming necessities for people on personal and professional levels. These devices may include cellular telephones, portable digital assistants (“PDAs”), portable game consoles, palmtop computers, and other portable electronic devices.

PCDs, like personal computers, often have memory management units (“MMUs”) for managing memory elements, such as Dynamic Random Access Memory (“DRAM”). These MMUs contain buffers inside them which are known as translation lookaside buffers (“TLBs”) that store the result of MMU operation (typically translation of virtual address value to it's physical address and access permissions).

This type of translation may use multiple levels for different reasons. MMUs use address tables to do lookups for arriving at the translated address. Apart from TLBs, there are other caches inside a MMU that may be used in MMUs in parallel with TLBs to generally improve performance of a MMU.

However, most MMUs and caches within the MMUs do not contain significant amounts of data, and thus make MMUs less efficient since an MMU must access memory, such as DRAM, if the contents of an address translation request are not present within the MMU. Such memory accesses by a MMU may consume significant amounts of power as the volume of memory requests increase within a PCD, when a PCD supports multiple and different types of application programs with varying degrees of memory demands.

Accordingly, what is needed in the art is a method and system for reducing power consumption while improving efficiency for a memory management unit of a portable computing device.

### SUMMARY OF THE DISCLOSURE

A method and system for reducing power consumption while improving efficiency of a memory management unit of a portable computing device are described. The method and system include determining if data of a memory request exists within a first memory element external to the memory management unit (“MMU”). The first memory element may include an external cache relative to the MMU. If the data of the memory request exists within the first memory element, then the data from the first memory element may be sent to the MMU. If the data of the memory request does not exist within the first memory element, then a magnitude of a burst length value of the memory request may be determined. Subsequently, a page table walk may be conducted with a second memory element, such as double-data rate memory, like DRAM, that corresponds with the magnitude of the burst length value of the second memory element. Each memory request may include a descriptor. The descriptor may have a reserved field region that includes a pre-fetch hint which indicates whether next descriptors in the second memory element are valid or not.

A page table walk may be conducted with the second memory element for data of the memory request and additional entries such that sum of the requests equal to the burst length value of the second memory element. According to one aspect, data corresponding to the memory request may be sent from the second memory element to the memory management unit and the first memory element may be updated with all additional entries or lesser entries that were retrieved from the second memory element.

### BRIEF DESCRIPTION OF THE DRAWINGS

In the figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1A is a functional block diagram illustrating an embodiment of a portable computing device (“PCD”) having a system for reducing power consumption while improving efficiency for a memory management unit of a portable computing device;

FIG. 1B is a front view of an exemplary embodiment of the PCD of FIG. 1A such as a mobile phone.

FIG. 2 is a functional block diagram illustrating an exemplary system for reducing power consumption while improving efficiency for a memory management unit of a portable computing device.

FIG. 3 illustrates an exemplary descriptor that may be part of a memory request which are handled by the system illustrated in FIGS. 1-2.

FIGS. 4A-4B are a logical flowchart illustrating a method for reducing power consumption while improving efficiency for a memory management unit of a portable computing device.

FIG. 5 illustrates one example of an external prefetch cache that is illustrated in FIG. 2.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon.

The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) and fourth generation (“4G”) wireless technology, greater bandwidth availability has enabled more portable computing devices with a greater variety of wireless capabilities.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) wireless technology, have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, and a laptop computer with a wireless connection, among others.

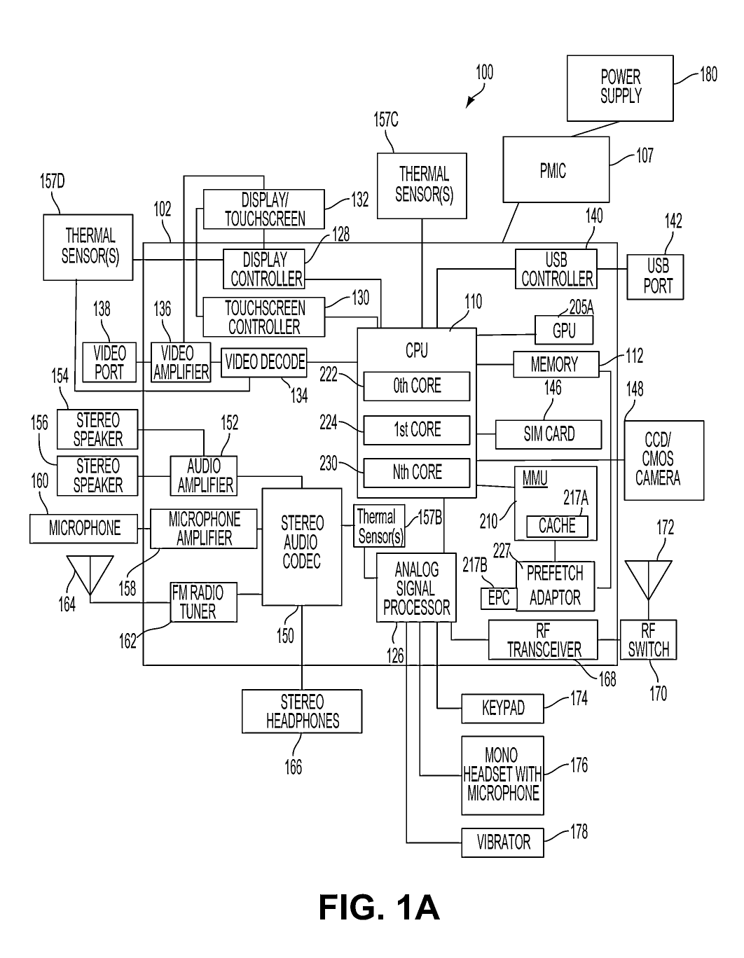

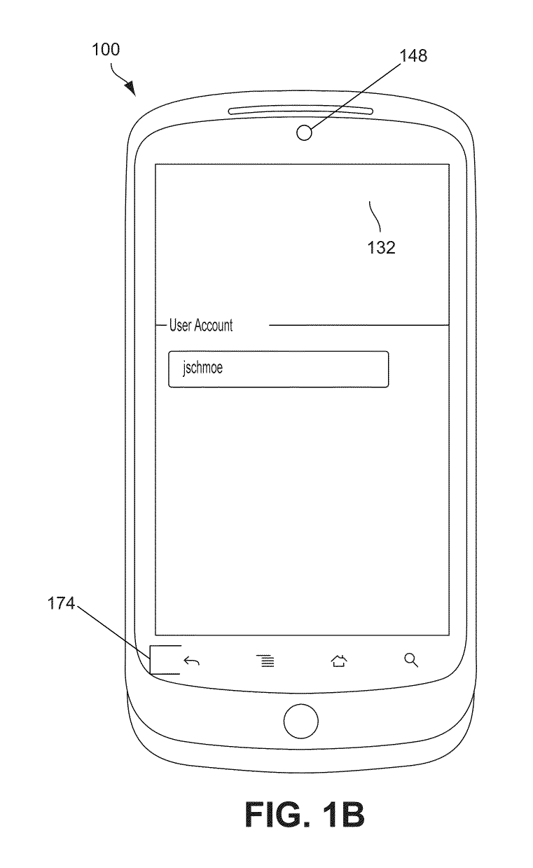

Referring to FIG. 1A, this figure is a functional block diagram of an exemplary, non-limiting aspect of a PCD 100 in the form of a wireless telephone for implementing a method and system for reducing power consumption while improving efficiency for a memory management unit of the PCD 100. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Instead of a CPU 110, a digital signal processor (“DSP”) may also be employed as understood by one of ordinary skill in the art.

The CPU 110 may also be coupled to one or more internal, on-chip thermal sensors 157A as well as one or more external, off-chip thermal sensors 157B. The PCD 100 may also include memory element 112 which is coupled to a memory management unit (“MMU”) 210. The MMU 210 may be coupled to the CPU 110. The MMU 210 is generally responsible for managing memory requests received from a plurality of multiple processing elements which may include processing elements, such as, but not limited to, CPU 110, and other additional processing elements not shown.

The MMU 210 comprises hardware that generally is responsible for having all memory references passed through itself, primarily performing the translation of virtual memory addresses to physical addresses. The MMU 210 is usually implemented as a separate physical entity relative to the plurality of processing elements 110, 205 that it may serve.

The MMU 210 may have its own cache or memory element 217A. The MMU 210 may also be coupled to a prefetch adapter 227. The prefetch adapter 227 may have its own external prefetch cache (EPC) 217B in which the adapter 227 may store its memory fetches from the memory element 112, that may comprise DDR type memory, such as, but not limited to, DRAM.

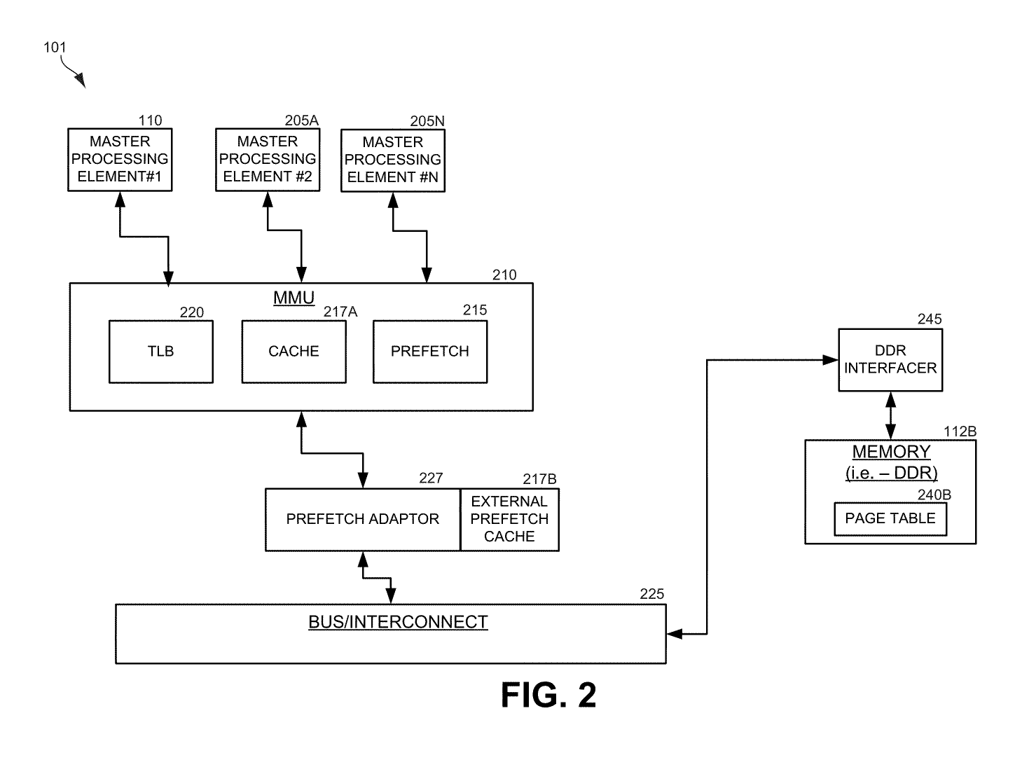

The prefetch adapter 227 may work with the memory management unit 210 in order to retrieve additional data from the memory element 112 that may be needed by the MMU 210 and related memory requests. Further details of the prefetch adapter 227 and the EPC 217B will be described below in connection with FIGS. 2-4.

In a particular aspect, one or more of the method steps described herein may be implemented by executable instructions and parameters, stored in the memory element 112. Further, the CPU 110 and its cores 222, 224, and 230; MMU 210; EPC 217B; the memory element 112; and/or instructions stored therein, or a combination thereof may serve as a means for performing one or more of the method steps described herein for reducing power consumption while improving efficiency for the memory management unit 210 of the portable computing device 100.

The power manager integrated controller (“PMIC”) 107 of the PCD 100 may be responsible for distributing power to the various hardware components present on the chip 102. The PMIC is coupled to a power supply 180. The power supply 180, may comprise a battery and it may be coupled to the on-chip system 102. In a particular aspect, the power supply may include a rechargeable direct current (“DC”) battery or a DC power supply that is derived from an alternating current (“AC”) to DC transformer that is connected to an AC power source.

As illustrated in FIG. 1A, a display controller 128 and a touchscreen controller 130 are coupled to the multi-core processor 110. A touchscreen display 132 external to the on-chip system 102 is coupled to the display controller 128 and the touchscreen controller 130. A graphics processing unit (“GPU”) 205A may be coupled to the central processing unit 110. The GPU 205A may transmit graphics data to the display controller 130 and/or the display screen 132.

FIG. 1A is a schematic diagram illustrating an embodiment of a portable computing device (“PCD”) that includes a video encoder/decoder 134. The video decoder 134 is coupled to the multicore central processing unit (“CPU”) 110. A video amplifier 136 is coupled to the video decoder 134 and the touchscreen display 132. A video port 138 is coupled to the video amplifier 136. As depicted in FIG. 1A, a universal serial bus (“USB”) controller 140 is coupled to the CPU 110. Also, a USB port 142 is coupled to the USB controller 140. A memory element 112 and a subscriber identity module (“SIM”) card 146 may also be coupled to the CPU 110.

Further, as shown in FIG. 1A, a digital camera or camera subsystem 148 may be coupled to the CPU 110. In an exemplary aspect, the digital camera/cameral subsystem 148 is a charge-coupled device (“CCD”) camera or a complementary metal-oxide semiconductor (“CMOS”) camera.

As further illustrated in FIG. 1A, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 1A shows that a microphone amplifier 158 may be also coupled to the stereo audio CODEC 150. Additionally, a microphone 160 may be coupled to the microphone amplifier 158.

In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 1A further indicates that a radio frequency (“RF”) transceiver 168 may be coupled to the analog signal processor 126. An RF switch 170 may be coupled to the RF transceiver 168 and an RF antenna 172. As shown in FIG. 1A, a keypad 174 may be coupled to the analog signal processor 126. Also, a mono headset with a microphone 176 may be coupled to the analog signal processor 126. Further, a vibrator device 178 may be coupled to the analog signal processor 126.

As depicted in FIG. 1A, the touchscreen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, and the power supply 180 are external to the on-chip system 102.

Referring now to FIG. 1B, this figure is a front view of one exemplary embodiment of a portable computing device (“PCD”) 100 such as a mobile phone. The PCD 100 has a large touchscreen 132 in its mid-section and smaller keypad/buttons 174 near a lower, first end of the device 100. A “frontward/user” facing camera 148 may be positioned near a top, second end of the device 100. While a touchscreen type mobile phone 100 has been illustrated, other mobile phone types are possible and are within the scope of this disclosure, such as mobile phones 100 that have dedicated key boards which may be placed in a fixed position or which may be slideable inward (in a hidden position) and outward (in a visible/usable position) relative to the device 100.

Referring now to FIG. 2, this figure illustrates a system 101 for reducing power consumption while improving efficiency for a memory management unit 210 of a portable computing device 100. The system 101 may comprise one or more master processing elements that may include CPU 110 and GPU 205, and additional master processing units 205N.

The system 101 further includes a MMU 210; a prefetch or buffer 215; a communication bus 225; an interfacer 224; and a memory element 112. The memory element 112 may include, but is not limited to, a double-data rate (“DDR”) type memory element 112, such as dynamic random access memory (“DRAM”). Other types of memory elements 112 may be used and are within the scope of this disclosure. The interfacer 245 may comprise a DDR interfacer for communicating commands to the DDR memory element 112. The DDR interfacer 245 may control the operation of DDR memory element 112.

The one or more master processing elements may include, but are not limited to, the central processing unit 110 which may be single core or multicore, the graphical processing unit 205A, a digital signal processor, and other like processing elements 205N for portable computing devices 101, such as mobile phones. Each master processing element 110, 205 may be coupled to the MMU 210 for managing its respective memory requests that are issued. The MMU 210 may comprise a cache 217, and a translation lookaside buffer (“TLB”) 220.

The TLB 220 may comprise a memory element, such as, but not limited to a buffer, that the MMU 210 uses to improve virtual address translation speed. A portable computing device, such as a mobile phone 100, desktop, laptop, and computer server processors may include one or more TLBs 220 in the memory management unit hardware 210, and it is usually present in any hardware that utilizes paged virtual memory.

The TLB 220 may be implemented as content-addressable memory (“CAM”) and it may have a CAM search key. The CAM search key may comprise the virtual address and the search result is a physical address. If a requested address is present in the TLB 220, the CAM search may yield a match quickly and the retrieved physical address can be used to access memory element 112. This is called a TLB hit.

If the requested address is not in the TLB 220, it is a “miss”, and MMU 210 may then check its cache 217A for the requested address. If the requested address is not present within cache 217A of MMU 210, then the MMU 210 proceeds to looking up in Prefetch 215. If the requested address is not present within Prefetch 215, then the MMU 210 proceeds to look up a page table in a process called a “hardware table walk.” The hardware table walk, relatively speaking, is an expensive process, as it involves reading the contents of multiple locations within the memory element 112 and using them to compute the physical address.

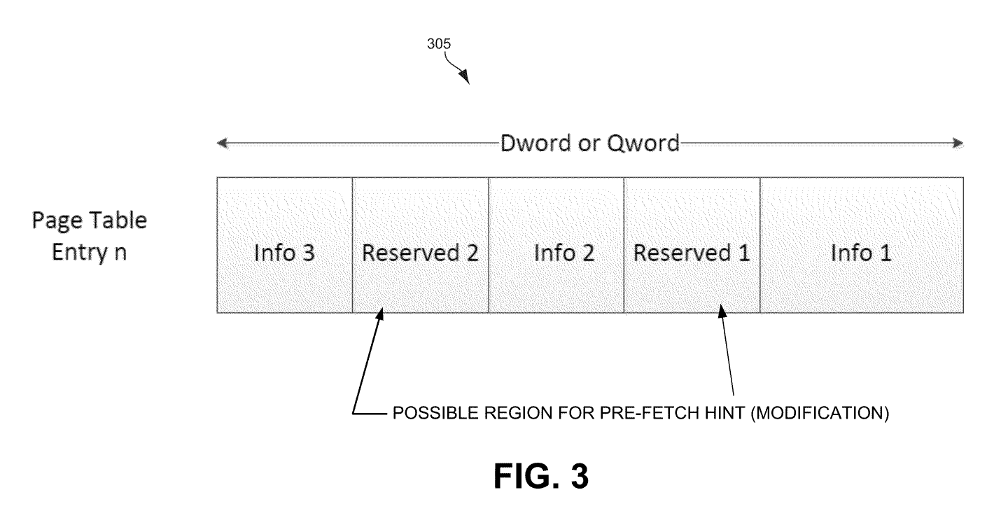

After the physical address is determined by the hardware table walk, the virtual address to physical address mapping is entered into the TLB 220 as understood by one of ordinary skill in the art. A master processing element 205 may issue a request to access the memory element 112 using a virtual address (“VA”) that may be retrieved from a descriptor 305 which is part of the memory request. Further details of descriptors 305 are illustrated in FIGS. 3A-3C and are described in more detail below. The memory request may also comprise a stream identifier.

The MMU 210 may receive each memory request and use the translation look-aside buffer (“TLB”) 220 based on the VA. Once the MMU 210 has confirmed that the VA was not present in the TLB 220 or its cache 217A or Prefetch 215, it may relay or hand-off the memory request that comprises retrieving descriptor 305 to the external prefetch adapter 227.

The external prefetch adapter 227 (relative to the MMU 210) has its own external prefetch cache 217B. The external prefetch adapter (“EPC”) 227 comprises hardware for assisting the MMU 210 with completing memory requests that have been issued by master processing elements 110, 205 and which were not found by the MMU 210.

When the external prefetch adapter 227 receives the memory request from the MMU 210, the EPC 227 may then determine if the data of the memory request, is present within the external prefetch cache 217B.

In computing, a “word” is a term for the natural unit of data used by a particular processor design. A word is basically a fixed-sized group of digits (binary or decimal) that are handled as a unit by an instruction set and/or hardware of the processor. The number of digits in a word (the word size, word width, or word length) may be an important characteristic of any specific processor design or computer architecture.

The size of a word is reflected in many aspects of a computer's structure and operation; the majority of the registers in a processor are usually word sized and the largest piece of data that can be transferred to and from the working memory in a single operation is a word in many (not all) architectures. The largest possible address size, used to designate a location in memory, is typically a hardware word.

Modern processors, including embedded systems, usually have a word size of 8, 16, 24, 32, or 64 bits, while modern general purpose computers usually use 32 or 64 bits. Data structures that may have different sized words usually refer to different sized words as follows: WORD (16 bits/2 bytes), DWORD (32 bits/4 bytes) and QWORD (64 bits/8 bytes) respectively.

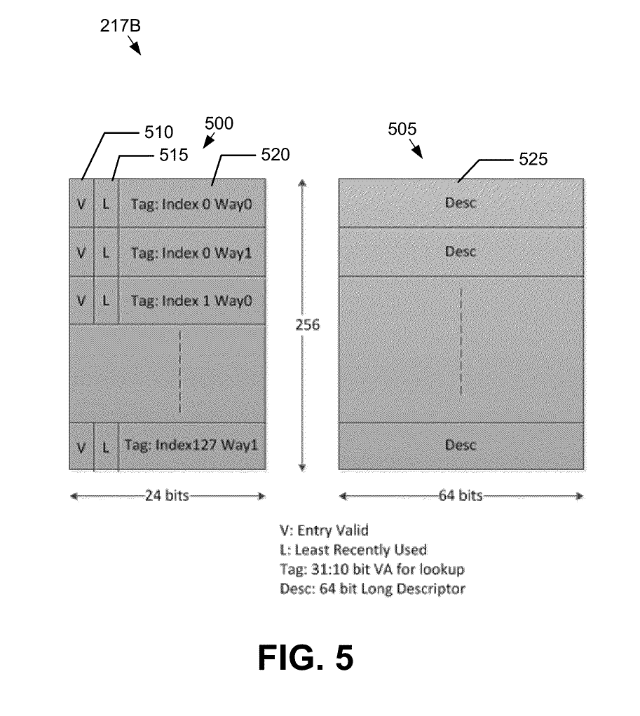

Referring back to FIG. 2, the external prefetch cache 217B may comprise a combination of hardware components. For example, the external prefetch cache 217B may comprise a register component 500 and a memory component 505 is will be described in further detail below in connection with FIG. 5. Other combinations of hardware components are possible and are within the scope of this disclosure as understood by one of ordinary skill the art.

If the data of a memory request is present within the external prefetch cache 217B, then the external prefetch adapter 227 may retrieve that data from the external prefetch cache 217B and send it back to the MMU 210. The external prefetch adapter 227 may then conduct a hardware page table walk using the system bus 225 to access the DDR interfacer 245.

The DDR interfacer 245 may allow the external prefetch adapter 227 to access the page table 240 in the memory element 112. The external prefetch adapter 227 may retrieve from the memory element 112 the next n entries relative to the entry listed in the descriptor 305 of the memory request such that n is less than burst length. The number n is usually a whole number which is less than the burst length. These next n memory entries from the memory element 112 may then be stored by the adapter 227 in the external prefetch cache 217B.

If the external prefetch cache 217B does not contain the contents of the memory request, then the external prefetch adapter 227 may then determine if the burst length value, also referred to as the arlen value relative to ARM™ brand processors, is set equal to a single DWORD.

If the burst length value is set equal to a single DWORD, then the external prefetch adapter 227 may then conduct a page table walk in the memory element 112 for the requested DWORD of the memory request as well as the next n memory entries or next n DWORDs. The external prefetch adapter 227 may then send the first retrieved DWORD corresponding to the memory request back to the MMU 21.

The external prefetch adapter 227 may then update the external prefetch cache 217B with the all n memory entries or n DWORDs. The external prefetch adapter 227 may drop or delete a few of the retrieved at memory entry out of n entries or DWORD.

If the burst length value of the memory request from the MMU 210 is greater than 1 DWORDs, such as n DWORDs, then the external prefetch adapter 227 may conduct a page table walk in the memory element 112 for a total of n+x, where x can be any whole number. For example, n may be equal to two while x can be equal to three. This means the external prefetch adapter 227 in this scenario may conduct a page table walk for five memory entries, such as a next five DWORDs.

In this specific, yet exemplary scenario where n=2 and x=3, the first two retrieved DWORDs from the memory element 112 by the external prefetch adapter 227 may then be relayed back to the MMU 210. Subsequently, the external prefetch adapter 227 may update the external prefetch cache 217B with the third and fourth and fifth memory entries, such as the third and fourth and fifth DWORDs.

In this way, the external prefetch adapter 227 may increase the speed in which the MMU 210 may retrieve data for memory requests generated by the master processors 110, 205. This retrieval of additional memory data by the external prefetch adapter 227, in turn lead to lesser number of bursts to memory element 112 thereby, decreasing the power consumption of the system (PCD 100) as understood by one of ordinary skill in the art. Further details about the external prefetch adapter 227, its external prefetch cache 217B, and its interactions with the MMU 210 will be described below.

FIG. 3 illustrates an example of a descriptor 305 and its associated bit field assignments which may be part of a memory request, as understood by one of ordinary skill in the art. “Short” descriptors 305, a term as understood by one of ordinary skill in the art, are those which may have bit lengths of thirty-two bits for use in older systems. This descriptor 305 may also have a bit length of sixty-four bits.

The descriptor 305C may have bit field assignments which are part of a memory request. Reserved bits, such as the illustrated reserved 2 region and reserve 1 region in FIG. 3, may comprise the pre-fetch hint. The pre-fetch hint conveys whether next descriptors in memory element 112 are valid or not.

In conventional descriptors 305, such as, but not limited to, first-level descriptors, second-level descriptors, and long-descriptor third-level descriptor formats as understood by one of ordinary skill in the art, the upper attributes, such as bits 56:55 of a descriptor entry may contain the pre-fetch hint which may be used to convey whether next descriptors in memory element 112 are valid or not. The pre-fetch hint information in these reserved bits, such as, but not limited to bits 56:55 in conventional descriptor formats, may be used by the external prefetch cache 217B to decide whether to update the cache 217B or drop elements from the cache 217B.

One example of a pre-fetch (“PF”) hint/value stored at reserved location as in FIG. 3 that can be used in a long descriptor format includes, but is not limited to, the following:

if the bit value is 00: this means the next descriptor is invalid;

if the bit value is 01: this means the next descriptor is valid and useful; and

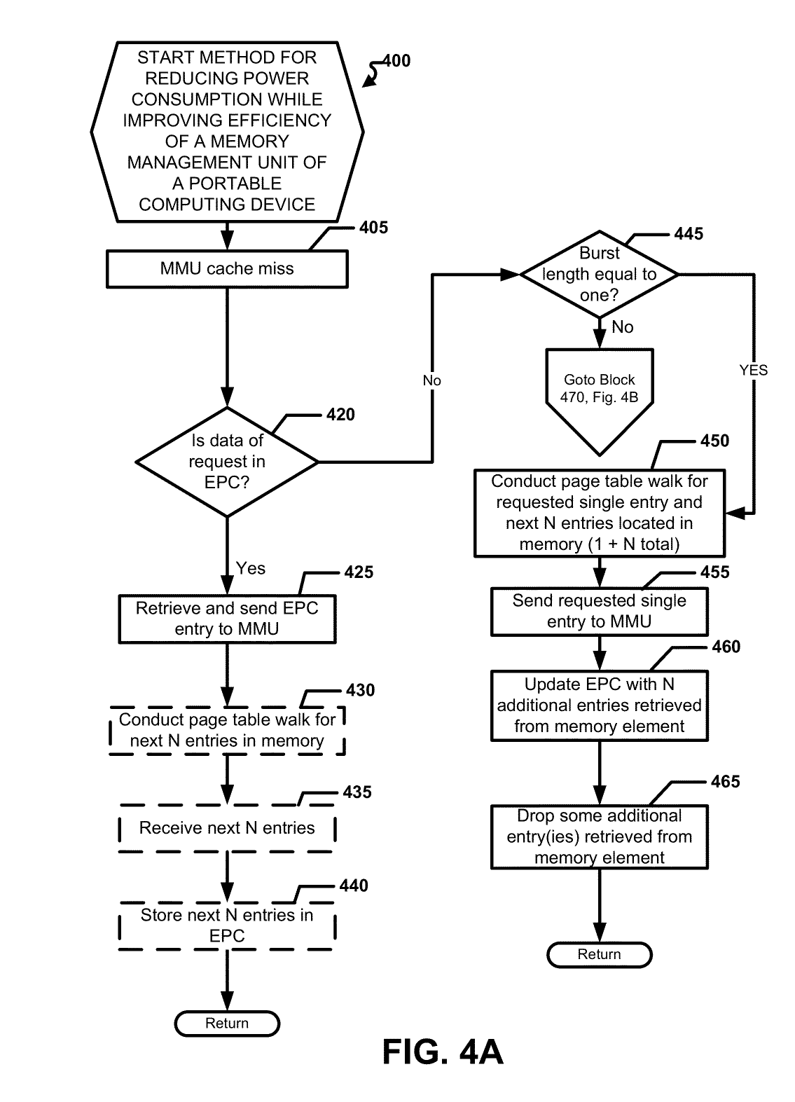

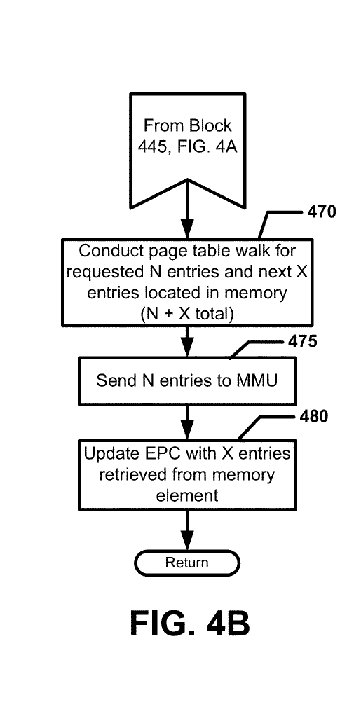

if the bit value is 10/11: this means the next two descriptors are valid and useful. The external prefetch adaptor 227 can look at the pre-fetch hint values as will be described in FIG. 4 mentioned below.

To support sections and pages, an MMU 210 may use a two-level descriptor definitions or a three-level descriptor definition. For two level descriptors 305, the first-level descriptor 305A may indicate whether the access is to a section or to a page table. If the access is to a page table, then the MMU 210 may determine the page table type and fetches a second-level descriptor 305B.

FIG. 4 is a logical flowchart illustrating a method 400 for reducing power consumption while improving efficiency of a memory management unit 210 of a portable computing device 100. Block 405 is the first block of method 400. In block 405, the MMU 210 receives a memory request and determines that its cache 217A does not have the contents/data associated with the memory request from a master processor 110 or 205. The MMU 210 then relays the memory request to the prefetch adapter 227.

Next, in decision block 420, the prefetch adapter 227 determines if the data, such as a DWORD, exists or is present within the external prefetch cache 217B. If the inquiry to decision block 420 is positive, then the “YES” branch is followed to block 425. If the inquiry to decision block 420 is negative, then the “NO” branch is followed to decision block 445.

In block 425, the prefetch adapter 227 retrieves and sends the external prefetch cache entry to the MMU 210. Subsequently, in optional block 430, the prefetch adapter 227 may conduct a page table walk within the memory element 112 for the next n entries/descriptors relative to the current memory request which was processed. In an exemplary embodiment, n may equal two but other values for n are possible.

Next, in optional block 435, the prefetch adapter 227 receives the next n entries (in our example, n may equal two) from the memory element 112 which may comprise the next n DWORDs as understood by one of ordinary skill in the art.

In optional block 440, these next n DWORDs may then be stored by the prefetch adapter 227 in the external prefetch cache 217B. Optional blocks 430-440 have been illustrated with dashed lines to signify that these steps are optional and may be skipped without departing from the scope of the present disclosure.

Referring back to decision block 420, if the inquiry to decision block 420 is negative, then the “NO” branch is followed to decision block 445. In decision block 445, the prefetch adapter 227 determines if the burst length of the present memory request (referred to as the “arlen” in the ARM™ brand of processing circuitry) set to one DWORDs or multiple. If the inquiry to decision block 445 is positive, meaning that the burst length of the present memory request is set to a single DWORD, then the “YES” branch is followed block 450. If the inquiry to decision block 445 is negative, then the “NO” branch is followed to block 470.

In block 450, the prefetch adapter 227 conducts a page table walk in memory element 112 for the requested data entry of the memory request, often a single DWORD. Further, in block 450, the prefetch adapter 227 may further conduct a page table walk in memory element 112 for n additional DWORDs, where n in one example may be set equal to three, however, other values for n are possible. The first entry was requested by the MMU 210 while the next n entries, such as n=3 entries, may be stored in the EPC 217B.

In block 455, the prefetch adapter 227 may send the first retrieved DWORD to the MMU 210. Subsequently, in block 460, the prefetch adapter 227 may update its external prefetch cache 217B with n or fewer DWORDs, out of the n additional DWORDs retrieved. In the example where n=3, this means a total of four DWORDs are retrieved: the first DWORD is sent back to the MMU 210 while the second and third DWORDs may be stored in the EPC 217B.

Next, in block 465, the prefetch adapter 227 may drop the last DWORD (for performance reasons), such as the fourth DWORD in an example with n additional DWORDs, where n=3, which was retrieved from memory element 112. Subsequently, the method 400 may then return to the beginning.

Referring back to decision block 445, if the inquiry to decision block 445 was negative, then the “NO” branch is followed to block 470. In block 470, the prefetch adapter 227 may conduct a single page table walk of n requested DWORDs (which includes the requested n DWORDs as well as an additional x DWORDs, such a x=2 additional DWORDs as an example) from the memory element 112.

Next, in block 475, because it was determined that the arlen or burst length is set to multiple n DWORDs, like two DWORDs, then the prefetch adapter 227 may then send the retrieved first two DWORDs back to the MMU 210. Subsequently, in block 480, the prefetch adapter two 227 may update its external prefetch cache 217B with the x additional DWORDs retrieved from the memory element 112. In an example where x=2, then the additional two DWORDs are stored in EPC 217B. The method 400 then returns back to the beginning of the process.

Referring now to FIG. 5, this figure illustrates one exemplary embodiment of the external prefetch cache 217B of the external prefetch adapter 227. The external prefetch patch 217B may comprise a combination of hardware components 500, 505. The first hardware component 500 may comprise a register that supports a plurality of data fields 510, 515, and 520. A first field 510 of the first hardware component 500 may be used as a validity status field to indicate whether or not an entry for the register is valid. The second field 515 may be used to support a least recently used (“LRU”) status field which corresponds to an LRU eviction scheme as will be described in further detail below. The third field 520 of the register hardware component 500 may comprise a tag index field as understood by one of ordinary skill the art.

Meanwhile, in the second hardware component 505 of the external prefetch cache 217B, descriptors 305 may be stored in fields 525. As noted above, the second hardware component 505 may comprise a memory element. Each hardware component 500, 505 may support 256 locations in order to ensure an average of two (2) locations per context assuming a maximum of 128 contexts as understood by one of ordinary skill in the art. The first hardware component 500 comprising a register may support Tag RAM which translates into a latency impact (miss) of approximately one cycle.

The lookup scheme supported by these two hardware components 500, 505 of the external prefetch patch 217B may be characterized as a two way set associative cache as understood by one of ordinary skill the art. Tag addresses which are part of memory requests are compared for hits or misses within the cache 217B.

For example, an input address may comprise a value of 31:3 (which is a 64-bit aligned address). The tag RAM address width would be equal to LOG 256/2way which equals 7. The tag RAM address value would be 9:3 of input address (seven bits). EPC hit or missed would then be determined by comparing the tag stored against input address 31:10.

The external prefetch cache 217B may support conventional invalidation schemes as well as eviction schemes as understood by one of ordinary skill the art. With respect to invalidation schemes, the external prefetch cache 217B may support SNOOP invalidation information that may be generated by ARM™ brand SMMU cores 210. According to another exemplary aspect, the external prefetch cache 217B may invalidate all of its entries for all types of invalidations. Alternatively, the external prefetch cache 217B may also support virtual machine identifier (“VMID”), address space identifier (“ASID”), and virtual address (“VA”) invalidation schemes.

Usually, when the cache 217A of the MMU 210 is executing in invalidation scheme, then a signal is transmitted to the external prefetch cache 217B in order to execute a similar or identical eviction scheme for its data. The MMU 210 or software running on one of the master processors 110, 205 may transmit the signal to the external prefetch cache 217B to initiate an eviction scheme for its data.

With respect to eviction schemes supported by the external prefetch cache 217B of the external prefetch adapter 227, least recently used based replacement schemes are supported and correspond with the LRU field 515 described above in connection with FIG. 5. With a least recently used based replacement scheme, an entry within the external prefetch cache 217B may be replaced depending on LRU bit of the entry as understood by one of ordinary skill the art.

In addition to the invalidation schemes and eviction schemes, the external prefetch cache 217B and the external prefetch adapter 227 may support various types of debugging mechanisms. For example, the prefetch cache 217B and the adapter 227 may support a global disable (bypass) debug mechanism. Each debugging mechanism may use the validity status field 510 in order to track potential errors within the system. The external prefetch cache 217B may support register based per location invalidation as well as register-based invalidate all type debugging mechanisms.

With the inventive system 101 and method 400 described above, performance of the MMU 210 may be improved due to reduced latency for page table walk (“PTW”) results. The inventive system 101 and method 400 may help in decreasing double data rate (“DDR”) traffic due to the support of the external prefetch adapter 227. This, in turn, may also substantially reduce dynamic power consumed within the PCD 100 due to the reduced activity on the DDR interface 245 and the memory element 112, such as DDR DRAM. Specifically, this dynamic power reduction may be attributed to a single burst of four entry memory access instead of the conventional single or two entry memory access.

Also, with the inventive system 101 and method 400, logic duplication is substantially reduced or eliminated. In other words, with the inventive system 101 and method 400 there is typically no need to check for faults, which may comprise levels of descriptors typically fetched and that is usually performed by the MMU 210. Further, the inventive method 400 and system 101 is generally transparent to any software that is running on respective master processors 110, 205.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium.

In the context of this document, a computer-readable medium is an electronic, magnetic, optical, or other physical device or means that may contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may include any means that may store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

Computer-readable media include both computer storage media and communication media including any medium that facilitates transfer of a computer program from one place to another. A storage media may be any available media that may be accessed by a computer. By way of example, and not limitation, such computer-readable media may comprise any optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for reducing power consumption while improving efficiency of a memory management unit of a portable computing device, the method comprising:
determining if data of a memory request exists within a first memory element external to the memory management unit;
if the data of the memory request exists within the first memory element, then retrieving the data from the first memory element and sending the data to the memory management unit; and
if the data of the memory request does not exist within the first memory element, then determining the magnitude of a burst length value of the memory request and conducting a page table walk with a second memory element that corresponds with the magnitude of the burst length value of the memory request.

2. The method of claim 1, further comprising conducting a page table walk with the second memory element for data of the memory request and n additional entries relative to the memory request, where n is a whole number.

3. The method of claim 2, further comprising sending the data corresponding to the memory request from the second memory element to the memory management unit and updating the first memory element with less than n additional entries.

4. The method of claim 2, further comprising sending data corresponding to the memory request from the second memory element to the memory management unit and updating the first memory element with n additional entries.

5. The method of claim 1, wherein the memory request comprises at least one descriptor.

6. The method of claim 1, wherein the first memory element comprises hardware external to the memory management unit.

7. The method of claim 6, wherein the hardware comprises cache memory.

8. The method of claim 1, wherein the second memory element comprises double-data rate type memory.

9. The method of claim 1, wherein the memory request comprises a descriptor, the descriptor comprising a reserved field region in which the reserved field region includes a pre-fetch hint that indicates whether next descriptors in the second memory element are valid or not.

10. A system for reducing power consumption while improving efficiency of a memory management unit of a portable computing device, the system comprising:
means for determining if data of a memory request exists within a first memory element external to the memory management unit;
means for retrieving the data from the first memory element and sending the data to the memory management unit if the data of the memory request exists within the first memory element; and
means for determining the magnitude of a burst length value of the memory request and conducting a page table walk with a second memory element that corresponds with the magnitude of the burst length value of the memory request if the data of the memory request does not exist within the first memory element.

11. The system of claim 10, further comprising means for conducting a page table walk with the second memory element for data of the memory request and n additional entries relative to the memory request, where n is a whole number.

12. The system of claim 11, further comprising means for sending the data corresponding to the memory request from the second memory element to the memory management unit and means for updating the first memory element with less than n additional entries.

13. The system of claim 12, further comprising means for sending data corresponding to the memory request from the second memory element to the memory management unit and means for updating the first memory element with n additional entries.

14. The system of claim 12, wherein the memory request comprises a descriptor, the descriptor comprising a reserved field region in which the reserved field region includes a pre-fetch hint that indicates whether next descriptors in the second memory element are valid or not.

15. A system for reducing power consumption while improving efficiency of a memory management unit of a portable computing device, the system comprising:
a processing element operable for:
determining if data of a memory request exists within a first memory element external to the memory management unit;
retrieving the data from the first memory element and sending the data to the memory management unit if the data of the memory request exists within the first memory element; and
determining the magnitude of a burst length value of the memory request if the data of the memory request does not exist within the first memory element and conducting a page table walk with a second memory element that corresponds with the magnitude of the burst length value of the memory request.

16. The system of claim 15, wherein the processing element is further operable for conducting a page table walk with the second memory element for data of the memory request and n additional entries relative to the memory request, where n is a whole number.

17. The system of claim 16, wherein the processing element is further operable for sending the data corresponding to the memory request from the second memory element to the memory management unit and updating the first memory element with less than the n additional entries.

18. The system of claim 17, wherein the processing element is further operable for sending data corresponding to the memory request from the second memory element to the memory management unit and updating the first memory element with the n additional entries.

19. The system of claim 15, wherein the memory request comprises a descriptor, the descriptor comprising a reserved field region in which the reserved field region includes a pre-fetch hint that indicates whether next descriptors in the second memory element are valid or not.

20. The system of claim 15, wherein the first memory element comprises hardware external to the memory management unit.
